(19) United States
(12) Patent Application Publication
(10) Pub. No.: US 2025/0028982 A1
(43) Pub. Date: Jan. 23, 2025

(54) COMPUTER-IMPLEMENTED METHOD AND DEVICE FOR GENERATING AN ANOMALY

(71) Applicant: Robert Bosch GmbH, Stuttgart (DE)

(72) Inventors: Julio Borges, Stuttgart (DE); Kevin Alexander Laube, Rottenburg Wurmlingen (DE)

(21) Appl. No.: 18/774,151

(22) Filed: Jul. 16, 2024

(30) Foreign Application Priority Data
Jul. 18, 2023 (DE) 10 2023 206 820.6

(51) Int. Cl. G06N 5/022; G06T 7/70; G06V 10/26; G06V 10/764; G06V 10/774; G06V 10/776; G06V 10/82

(52) U.S. Cl. CPC G06N 5/022; G06T 7/70; G06V 10/764; G06V 10/776; G06T 2207/20081; G06T 2207/20084; G06V 10/26; G06V 10/774; G06V 10/82

(57) ABSTRACT

Apparatus and computer-implemented method for generating an anomaly. A first representation of a digital input, including a digital time series, a digital audio signal, or a digital image, preferably a video image, a radar image, a LiDAR image, an ultrasound image, an image from a motion sensor, or an infrared image, in a state space is mapped onto the digital input using a first model which is configured to map the first representation onto the digital input. The digital input is mapped onto a prediction for a content contained in the digital input using a second model which is configured to map the digital input onto the prediction. A second representation in the state space which degrades the prediction is determined based on a measure that characterizes a quality of the prediction. The anomaly is generated based on the second representation.

### BACKGROUND INFORMATION

Models for the automated processing of digital inputs are used in various fields. Such models can include systematic errors that lead to undesirable anomalies.

### SUMMARY

An apparatus and the method according to features of the present invention make it possible to generate an anomaly in a model.

According to an example embodiment of the present invention, the computer-implemented method provides that a first representation of a digital input, in particular a digital time series, a digital audio signal, or a digital image, preferably a video image, a radar image, a LiDAR image, an ultrasound image, an image from a motion sensor, or an infrared image, in a state space is mapped onto the digital input using a first model which is designed to map the first representation onto the digital input, the digital input is mapped onto a prediction for a content contained in the digital input using a second model which is designed to map the digital input onto the prediction, wherein a change in the first representation which degrades the prediction is determined on the basis of a measure that characterizes a quality of the prediction, wherein a second representation in the state space is determined on the basis of the first representation and the change, and wherein the anomaly is generated on the basis of the second representation. The first representation and the second representation is, e.g., a vector in the state space. The content of a digital image is, e.g., an object shown in the digital image, e.g., a person or an item, e.g., a vehicle or a traffic sign. The first representation and second representation define a concept that is independent of the content. In the case of a digital image, the concept is, e.g., a weather condition or a lighting situation in which the digital image was captured. The method determines the second representation, which generates a problematic input. As a result, the anomaly is determined in the state space.

According to an example embodiment of the present invention, the first representation is selected randomly, for example, or is determined using a third model, which is designed to map the digital input onto the first representation, on the basis of the digital input. By randomly selecting different first representations, different starting points can be specified for determining the second representation. The third model can be used to predict the relevant starting point. The third model is, e.g., an inverse model with respect to the first model.

According to an example embodiment of the present invention, the prediction preferably comprises a classification of the content or a position of the content in the digital input. This means that the object is classified or a location of the object is determined.

In one example embodiment of the present invention, the first representation represents a semantic concept for a content contained in the digital input. The semantic concept describes e.g. the weather condition or the lighting situation in the digital image. This means that the first model can be used to map different semantic concepts to respective digital inputs.

In one example embodiment of the present invention, the first model is designed to map a description of a content to be provided in the digital input and the first representation onto the digital input, wherein the first model is used to map the description of the content to be provided in the digital input and the first representation onto the digital input. This means that the first model can be used to map different descriptions to respective digital inputs.

According to an example embodiment of the present invention, it can be provided that the second representation is mapped using the first model onto a digital input, in particular a digital time series, a digital audio signal, or a digital image, preferably a video image, a radar image, a LiDAR image, an ultrasound image, an image from a motion sensor, or an infrared image. This means that the second representation can be used to generate a training data point which is likely to be problematic in terms of correct prediction using the second model.

According to an example embodiment of the present invention, it can be provided that the first model is designed to map a description of a content to be provided in the digital input and the second representation onto the digital input, wherein the first model is used to determine one digital input each for different descriptions on the basis of the second representation, wherein the prediction is determined for each digital input using the second model, wherein it is checked whether at least a portion of the predictions has a common property, and wherein a second representation suitable for generating the anomaly is recognized if the portion of the predictions has the common property. The second representation generates this property consistently. This means that the problem lies with the second model and not with a single digital input. In a digital image, for example, the property is a similarity between the color of the object and the color of a background. The property is e.g. an inability of the second model to make a prediction or a prediction with sufficient confidence for the digital inputs. The inability is based, for example, on the fact that the content, e.g. the object, is unknown to the second model.

In one example embodiment of the present invention, the second representation is determined for different second models, wherein a second representation suitable for generating the anomaly is recognized if a distance between the second representations determined for the different second models is smaller than a predefined threshold. The distance can be a cosine distance between vectors representing the second representation. Second models, in particular second models of the same type, may have similar problems. If the distance is small, the concept associated with the second representations is problematic for the second models. If, on the other hand, the distance is large, the concept is less problematic.

According to an example embodiment of the present invention, it can be provided that, for the same description of the content to be represented and different second representations, a frequency with which an anomaly is recognized is determined, wherein a robustness of the second model against a change in the prediction is determined on the basis of the frequency.

The method is preferably performed without human control.

According to an example embodiment of the present invention, the method preferably provides that the second model is designed to control a technical system on the basis of the prediction, wherein the technical system is controlled on the basis of the prediction of the second model.

According to an example embodiment of the present invention, the apparatus for generating an anomaly comprises at least one processor and at least one memory, wherein the at least one processor is designed to execute instructions stored on the at least one memory, and the method of the present invention is carried out upon execution of said instructions by the at least one processor. The apparatus has advantages that correspond to those of the method.

A computer program comprises instructions that are executable by at least one processor, and the method of the present invention is carried out upon execution of said instructions by the at least one processor. The computer program has advantages that correspond to those of the method.

Further advantageous embodiments of the present invention can be found in the following description and the figures.

### BRIEF DESCRIPTION OF THE DRAWINGS

FIG. 1 shows a schematic representation of an apparatus for generating an anomaly, according to an example embodiment of the present invention.

FIG. 2 shows a schematic representation of a system for generating and processing images by means of machine learning, according to an example embodiment of the present invention.

FIG. 3 shows a flow chart with steps in a method for generating the anomaly, according to an example embodiment of the present invention.

### DETAILED DESCRIPTION OF EXAMPLE EMBODIMENTS

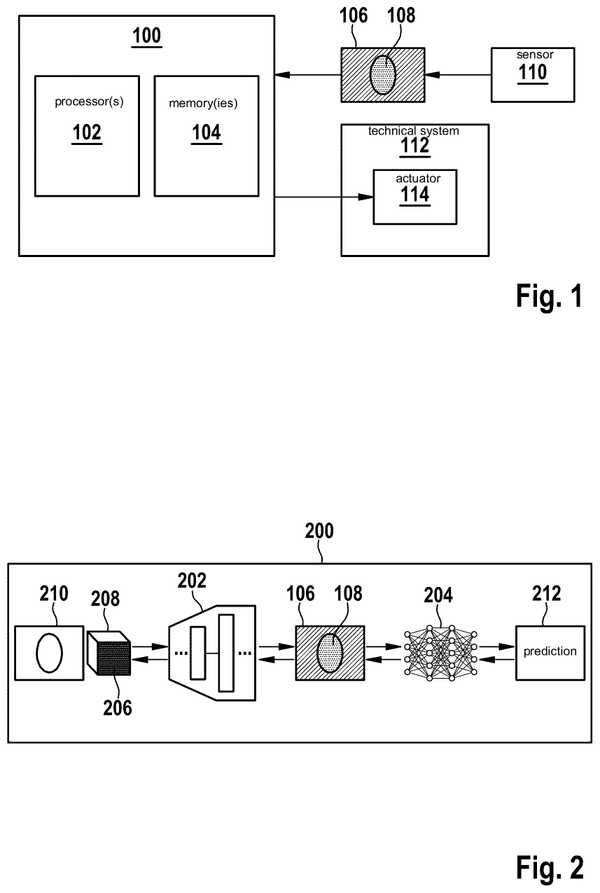

FIG. 1 schematically shows an apparatus 100 for generating an anomaly.

The apparatus 100 comprises at least one processor 102 and at least one memory 104. The at least one processor 102 is designed to execute instructions stored on the at least one memory 104, and a method described below for generating the anomaly is carried out upon execution of said instructions by the at least one processor 102.

A computer program that comprises the instructions that are executable by the at least one processor 102 can be provided.

The apparatus 100 is designed to process a digital input 106. The digital input 106 comprises a content 108. The content 108 is, for example, a pedestrian, a vehicle or a road.

The digital input 106 is e.g. a digital image, in particular a video image, a radar image, a LiDAR image, an ultrasound image, an infrared image, or an image from a motion sensor. The digital input 106 is e.g. a digital time series or a digital audio signal.

It can be provided that the digital input 106 is captured by a sensor 110. The sensor 110 is e.g. a camera, a radar sensor, a LiDAR sensor, an ultrasonic sensor, an infrared sensor, or a microphone. It can be provided that the sensor 110 is designed to detect a digital time series of a physical variable, in particular a speed, an acceleration, a yaw rate or a rotation angle. It can be provided that the apparatus 100 comprises the sensor 110.

In the example, the apparatus 100 is designed to control a technical system 112.

It can be provided that the apparatus 100 is designed to control an actuator 114 using a signal that is based on the digital input 106. It can be provided that the apparatus comprises the actuator 114.

The technical system 112 is a physical system, e.g. a robot, in particular a vehicle, a tool, a household appliance, a medical device, a personal assistance system or an access control system.

FIG. 2 shows a schematic representation of a system 200 for generating and processing images by means of machine learning.

The system 200 comprises a first model 202 for generating images and a second model 204 for processing images. The first model 202 is e.g. a deep neural network. The second model 204 is e.g. a deep neural network.

The first model 202 is designed to map a first representation 206 of the digital input 106 from a state space 208 and a description 210 of a content 108 to be provided in the digital input 106 onto the digital input 106.

The first model 202 is e.g. a generator that is designed to map a semantic concept encoded by the first representation 206 and the description 210 onto the digital input 106.

For example, the digital input 106 is a digital image. The content 108 is, for example, a pedestrian, a vehicle or a road.

The semantic concept is, for example, a weather condition or a lighting situation.

The second model 204 is designed to map the digital input 106 onto a prediction 212. On the basis of the prediction 212 and a measure m for a quality of the prediction 212, the system 200 is designed to determine a change 214 in the first representation 206 that degrades the prediction 212.

The second model 204 is e.g. a classifier, wherein the prediction 212 comprises a class for the content 108 contained in the digital input 106.

The second model 204 is designed e.g. for semantic segmentation, wherein the prediction 212 comprises semantic segmentation for the content 108 contained in the digital input 106.

The second model 204 is designed e.g. for object recognition, wherein the prediction 212 comprises a position of a content 108 contained in the digital input 106, i.e. the object.

In the example, the instructions define the system 200 for machine learning.

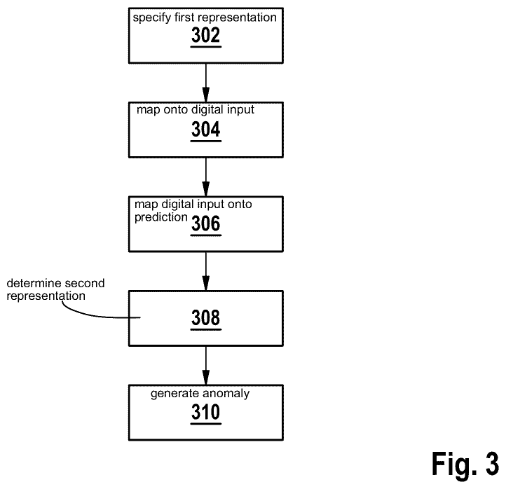

FIG. 3 shows a flow chart with steps in the method for generating the anomaly. The method is performed automatically, i.e. without human control.

The method is based on the system 200 for machine learning. The method is described using the example of the generation of the anomaly in the second model 204.

The method comprises a step 302.

In step 302, the first representation 206 is specified.

The first representation 206 is selected at random in the example.

The first representation 206 represents e.g. a semantic concept for the content 108 contained in the digital input 106.

In the example, the description 210 of the content 108 to be provided in the digital input 106 is specified.

Depending on the optimization method used, it may be possible that the specified first representation 206 leads to a local optimum. Therefore, it can be provided that the method is performed for different specified first representations 206, wherein the second representation that leads to the greatest degradation of the prediction 212 is determined.

This can be avoided e.g. using a third model that approximates an inverse function of the first model 202. The third model is e.g. a deep neural network. For example, a style encoder network that approximates the inverse function of the generator is provided. It can be provided that the digital input 106 is specified from training data and the first representation 206 is determined using a third model. The third model is designed e.g. to map the digital input 106 onto the first representation 206. The first representation 206 is determined e.g. using the third model on the basis of the digital input 106.

A step 304 is subsequently executed.

In step 304, the first representation 206 of the digital input 106 is mapped onto the digital input 106 using the first model 202.

In the example, the description 210 of the content 108 to be provided in the digital input 106 and the first representation 206 are mapped onto the digital input 106.

A step 306 is subsequently executed.

In step 306, the digital input 106 is mapped onto the prediction 212 using a second model 204.

The prediction 212 can comprise the classification of the content 108 or a position of the content 108 in the digital input 106. A step 308 is subsequently executed.

In step 308, on the basis of the measure that characterizes the quality of the prediction 212, a second representation in the state space 208 that degrades the prediction 212 is determined. For example, the second representation v is determined as:

$$v = arg {min}_{v} {E}_{s ∈ S} [ m ( M ( G ( v , s ) ) , s ) ]$$

wherein

G represents the first model 202, M the second model 204, m the measure, s the description 210 from a set of descriptions S and E the expected value.

In the example, the measure m is selected to match the prediction 212 used, i.e., for example, the measure m for the classification is a classification accuracy, for the semantic segmentation it is an intersection over union, IoU, and for the object recognition it is a regression loss.

Preferably, the first model 202 and the second model 204 are differentiable. The second representation v is determined, for example, by a gradient descent method.

A step 310 is subsequently executed.

In step 310, the anomaly is generated on the basis of the second representation v.

For example, the first model 202 is used to determine a digital input for different descriptions in each case on the basis of the second representation v. For each digital input, for example, the prediction 212 is determined using the second model 204. In the example, it is checked whether at least a portion of the predictions has a common property, and a second representation v suitable for generating the anomaly is recognized if the portion of the predictions has the common property.

For example, the second representation v is determined for different second models and a second representation v suitable for generating the anomaly is recognized if a distance between the second representations determined for the different second models is smaller than a predefined threshold.

For example, for the same description of the content to be represented and different second representations v, a frequency with which an anomaly is generated is determined. A robustness of the second model 204 against a change in the prediction 212 is determined e.g. on the basis of the frequency.

Robustness is recognized e.g. if the frequency is less than a specified threshold.

It can be provided that the second representation v is mapped using the first model 202 onto a digital input which is assigned to the second representation v.

In the example, this digital input is of the same type as the digital input 106 assigned to the first representation 206, in particular a digital time series, a digital audio signal, or a digital image, preferably a video image, a radar image, a LiDAR image, an ultrasound image, an image from a motion sensor, or an infrared image.

This digital input can supplement the training data with a training data point that is already known to be problematic for the second model 204.

A determination of a plurality of second representations v can be provided. A determination of a plurality of digital inputs for these second representations v can be provided. As a result, the training data is supplemented by a plurality of training data points which are problematic for the second model 204.

It can be provided to train the second model 204 using these additional training data points.

In one example, the digital input 106 characterizes a state of the technical system 112 or an environment of the technical system 112. The digital image, the digital time series or the digital audio signal characterizes the state, for example. This means that the second model 204 determines the prediction 212 on the basis of the state.

The second model 204 is designed e.g. to control the technical system 112 on the basis of the prediction 212 for the digital input 106. This means e.g. that the second model 204 is designed to determine the signal for controlling the actuator, i.e. for controlling the technical system 112, on the basis of the prediction 212.

For example, training is provided in which additional anomalies are generated as training data for the second model 204. It can be provided to train the second model 204 with the anomalies and as a result make it more robust. As a result, anomalies that did not previously occur during training are subsequently less problematic for the prediction 212 and the control of the technical system 112.

1-13. (canceled)

14. A computer-implemented method for generating an anomaly, the method comprising the following steps:
mapping a first representation of a digital input in a state space onto the digital input using a first model which is configured to map the first representation onto the digital input, the digital input including a digital time series, or a digital audio signal, or a digital image, or a video image, or a radar image, or a LiDAR image, or an ultrasound image, or an image from a motion sensor, or an infrared image;
mapping the digital input onto a prediction for a content contained in the digital input using a second model which is configured to map the digital input onto the prediction;
determining a second representation in the state space which degrades the prediction based on a measure that characterizes a quality of the prediction; and
generating the anomaly based on the second representation.

15. The method according to claim 14, wherein: (i) the first representation is randomly selected, or (ii) the first representation is determined using a third model which is configured to map the digital input onto the first representation based on the digital input.

16. The method according to claim 14, wherein the prediction: (i) includes a classification of the content, or (ii) includes a position of the content in the digital input.

17. The method according to claim 14, wherein the first representation represents a semantic concept for a content contained in the digital input.

18. The method according to claim 14, wherein the first model is configured to map a description of a content to be provided in the digital input and the first representation onto the digital input, wherein the first model is used to map the description of the content to be provided in the digital input and the first representation onto the digital input.

19. The method according to claim 14, wherein the second representation is mapped using the first model onto a digital input including a digital time series, or a digital audio signal, or a digital image, or a video image, or a radar image, or a LiDAR image, or an ultrasound image, or an image from a motion sensor, or an infrared image.

20. The method according to claim 14, wherein the first model is configured to map a description of a content to be provided in the digital input and the second representation onto the digital input, wherein the first model is used to determine one digital input each for different descriptions based on the second representation, wherein the prediction is determined for each digital input using the second model, wherein it is checked whether at least a portion of the predictions has a common property, and wherein a second representation suitable for generating the anomaly is recognized when the portion of the predictions has the common property.

21. The method according to claim 14, wherein the second representation is determined for different second models, wherein a second representation suitable for generating the anomaly is recognized when a distance between the second representations determined for the different second models is smaller than a specified threshold.

22. The method according to claim 20, wherein, for the same description of the content to be represented and different second representations, a frequency with which an anomaly is generated is determined, and wherein a robustness of the second model against a change in the prediction is determined based on the frequency.

23. The method according to claim 14, wherein the method is performed without human control.

24. The method according to claim 14, wherein the second model is configured to control a technical system based on the prediction, and wherein the technical system is controlled based on the prediction of the second model.

25. An apparatus configured to generate an anomaly, comprising:
at least one processor; and
at least one memory, wherein the at least one processor is designed to execute instructions stored on the at least one memory, the instructions, when executed by the at least one processor, causing the at least one processor to the following steps:
mapping a first representation of a digital input in a state space onto the digital input using a first model which is configured to map the first representation onto the digital input, the digital input including a digital time series, or a digital audio signal, or a digital image, or a video image, or a radar image, or a LiDAR image, or an ultrasound image, or an image from a motion sensor, or an infrared image,
mapping the digital input onto a prediction for a content contained in the digital input using a second model which is configured to map the digital input onto the prediction,
determining a second representation in the state space which degrades the prediction based on a measure that characterizes a quality of the prediction, and
generating the anomaly based on the second representation.

26. A non-transitory computer-readable medium on which is stored a computer program including for generating an anomaly, the instructions, when executed by at least one processor, causing the at least one processor to perform the following steps:
mapping a first representation of a digital input in a state space onto the digital input using a first model which is configured to map the first representation onto the digital input, the digital input including a digital time series, or a digital audio signal, or a digital image, or a video image, or a radar image, or a LiDAR image, or an ultrasound image, or an image from a motion sensor, or an infrared image;
mapping the digital input onto a prediction for a content contained in the digital input using a second model which is configured to map the digital input onto the prediction;
determining a second representation in the state space which degrades the prediction based on a measure that characterizes a quality of the prediction; and
generating the anomaly based on the second representation.
